(19) United States
(12) Patent Application Publication
(10) Pub. No.: US 2018/0239782 A1
(43) Pub. Date: Aug. 23, 2018

(54) IMAGE PROCESSING SYSTEM, IMAGE PROCESSING METHOD, AND PROGRAM STORAGE MEDIUM

(71) Applicant: NEC CORPORATION, Tokyo (JP)

(72) Inventors: Yasuji SAITO, Tokyo (JP); Junpei YAMASAKI, Tokyo (JP)

(73) Assignee: NEC CORPORATION, Tokyo (JP)

(21) Appl. No.: 15/554,802

(22) PCT Filed: Mar. 2, 2016
(86) PCT No.: PCT/JP2016/001124

§ 371 Date: Aug. 31, 2017

(30) Foreign Application Priority Data
Mar. 2, 2015 (JP) 2015-040141

(51) Int. Cl. G06F 17/30

(52) U.S. Cl. CPC G06F 17/30247; G06F 17/30268

(57) ABSTRACT

In order to shorten a time needed to extract an image meeting conditions from among a plurality of images, an image processing system 104 is provided with a detection unit 1043 and an acquisition unit 1044. From among a plurality of second images obtained by means of processing of reducing the capacitance of a plurality of first images, i.e., images to be processed, and/or processing of extracting an image meeting extraction conditions from among the first images, the detection unit 1043 detects a second image meeting retrieval conditions. The acquisition unit 1044 acquires, from among the first images or a plurality of generated images that are generated on the basis of the first images, an image corresponding to the second image detected by means of the detection unit.

### TECHNICAL FIELD

The present invention relates to a technique for reducing the time it takes to perform image search processing for searching an image.

### BACKGROUND ART

Image processing systems are widely spread, and the image processing systems uses the image taken by imaging devices such as surveillance cameras installed in shops and towns to detect and monitor people and objects and provide information about incidents and accidents. An example of such an image processing system is disclosed in PTL 1.

The image processing system in PTL 1 is a system that monitors an area to be monitored. In this monitor system, a face is detected by an image processing from the image taken by the imaging device, and features of the detected face are extracted. Then, the extracted features are collated with the information in the registrant list stored in the storage unit, and a determination is made as to whether or not the face shown in the captured image is the face of the registrant.

### CITATION LIST

### Patent Literature

### [PTL 1] Publication of Patent in Japan No. 5500303

### SUMMARY OF INVENTION

### Technical Problem

However, in the above system, all the captured images captured by the imaging device are to be processed in the face detection processing. For this reason, there is a problem that, when the processing load of the images to be processed is high, for example, when a particular person is detected from the captured image, it takes a long time to detect the particular person. When an attempt is made to reduce the processing time, it is necessary to introduce a high-performance processing device having a high processing ability, and since a high-performance processing device is expensive, this results in a problem of a higher cost.

The present invention has been made in order to solve the above-mentioned problem. More specifically, it is a main object of the present invention to provide a technique for reducing the time it takes to perform processing for extracting an image that matches a condition from among multiple images.

### Solution to Problem

To achieve the main object, an image processing system recited in the present invention includes:

a detection unit that detects a second image satisfying a search condition from a plurality of second images, the plurality of second images being obtained by performing processing of any one of or both of processing for reducing a size of a first image which is an image to be processed and processing for extracting an image satisfying an extraction condition from among a plurality of first images which are images to be processed; and

an obtainment unit that obtains an image depending on the second image detected by the detection unit from the plurality of first images or a plurality of generated images generated from the first images.

An image processing method recited in the present invention includes:

detecting a second image satisfying a search condition from a plurality of second images, the plurality of second images being obtained by performing processing of any one of or both of processing for reducing a size of a first image which is an image to be processed and processing for extracting an image satisfying an extraction condition from among a plurality of first images which are images to be processed; and

obtaining an image depending on the second image detected from the plurality of first images or a plurality of generated images generated from the first images.

In a program storage medium recited in the present invention, the program storage medium stores a processing procedure for causing a computer to execute:

detecting a second image satisfying a search condition from a plurality of second images, the plurality of second images being obtained by performing processing of any one of or both of processing for reducing a size of a first image which is an image to be processed and processing for extracting an image satisfying an extraction condition from among a plurality of first images which are images to be processed; and

obtaining an image depending on the second image detected from the plurality of first images or a plurality of generated images generated from the first images.

It should be noted that the main object of the present invention can also be achieved by an image processing method according to the present invention according to the image processing system recited in the present invention. Further, the main object of the present invention can also be achieved by a computer program according to the image processing system recited in the present invention and the image processing method recited in the present invention and a program storage medium storing the computer program.

### Advantageous Effects of Invention

According to the present invention, the processing for extracting an image that matches a condition from among multiple images can be performed in a shorter period of time.

### BRIEF DESCRIPTION OF DRAWINGS

FIG. 1 is a block diagram schematically illustrating a configuration of an image processing system according to a first example embodiment recited in the present invention.

FIG. 2 is a diagram illustrating a specific example of identification information.

FIG. 3 is a diagram for explaining an example of a generation method of a second image.

FIG. 4 is a diagram illustrating an example of data of distances between shops.

FIG. 5 is a diagram for explaining an example of obtainment of a first image by an obtainment unit.

FIG. 6 is a diagram for explaining another example of obtainment of the first image by the obtainment unit.

FIG. 7 is a sequence diagram explaining a processing flow of an image processing system according to a first example embodiment.

FIG. 8 is a simplified block diagram illustrating a configuration of an image processing system according to a second example embodiment recited in the present invention.

FIG. 9 is a simplified block diagram illustrating a configuration of an image processing system according to a third example embodiment recited in the present invention.

FIG. 10 is a figure illustrating an example of display displayed on a display unit of a user terminal according to the third example embodiment.

FIG. 11 is a simplified block diagram illustrating a configuration of the image processing system according to the fourth example embodiment recited in the present invention.

FIG. 12 is a simplified block diagram illustrating a configuration of an image processing system according to a fifth example embodiment recited in the present invention.

FIG. 13 is a simplified block diagram illustrating a configuration of an image processing system according to a sixth example embodiment recited in the present invention.

FIG. 14 is a block diagram illustrating an example of a hardware configuration.

FIG. 15 is a simplified block diagram illustrating a configuration of an image processing system according to a seventh example embodiment recited in the present invention.

FIG. 16 is a simplified block diagram illustrating a configuration of an image processing system according to an eighth example embodiment recited in the present invention.

### DESCRIPTION OF EMBODIMENTS

Hereinafter, embodiments according to the present invention will be described with reference to the drawings.

### First Example Embodiment

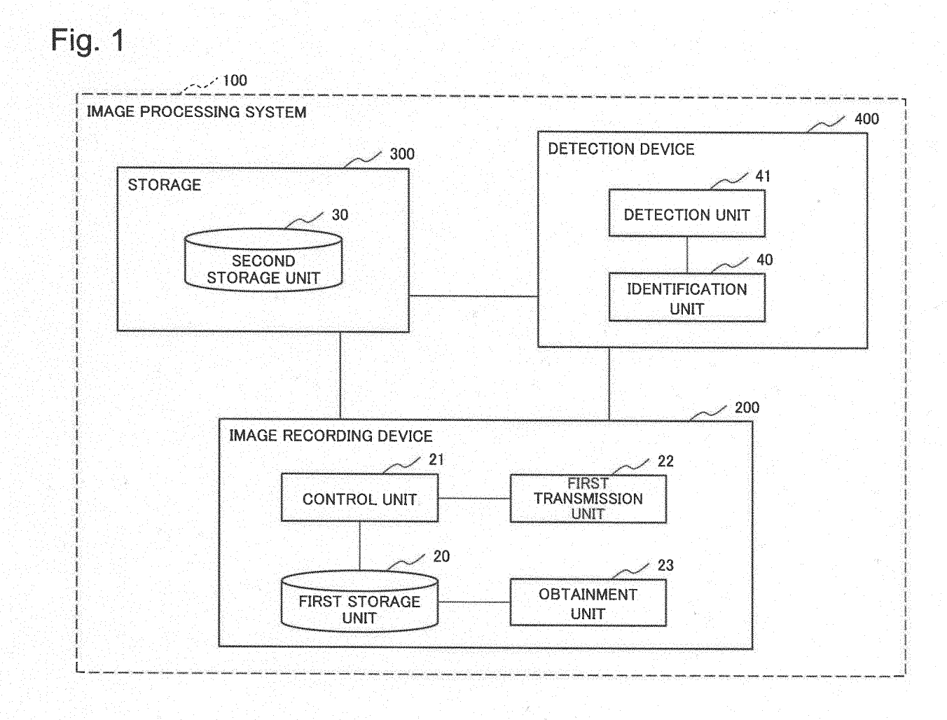

FIG. 1 is a block diagram schematically illustrating the configuration of the first example embodiment recited in the present invention. An image processing system 100 according to the first example embodiment includes an image recording device 200, a storage 300, and a detection device 400. Information communication between these devices is achieved through an information communication network.

The image recording device 200 includes a first storage unit 20, a control unit 21, a first transmission unit 22, and an obtainment unit 23. The image recording device 200 is connected to an imaging device (not shown) such as a camera. The first storage unit 20 of the image recording device 200 stores the captured image captured by the imaging device as a first image. In addition, the first storage unit 20 stores identification information for identifying the first image. The first image and the identification information about the first image are associated with each other and stored in the first storage unit 20.

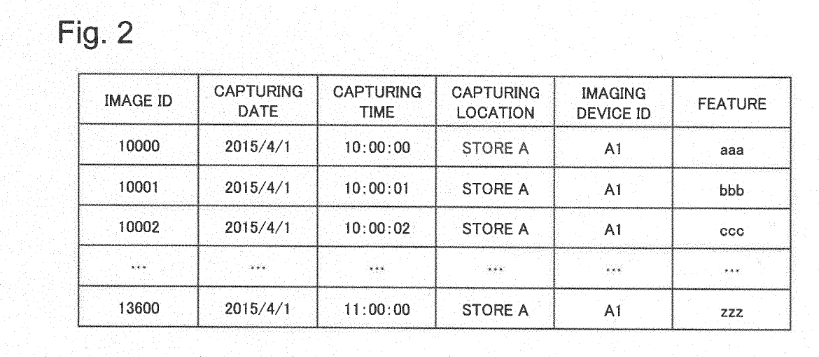

Hereinafter, a specific example of the identification information will be given. FIG. 2 is a diagram illustrating a specific example of the identification information in a table. In the example of FIG. 2, multiple pieces of identification information are associated with an image ID (IDentification) which is identification information about an image. The identification information shown in FIG. 2 include “capturing date”, “capturing time”, “capturing location”, “identification information (ID (IDentification)) about imaging device”, and “feature of image”. As shown in the identification information of FIG. 2, it is understood that the images having the image IDs 10000 to 13600 are images captured by an “imaging device A1” in a “store A” on “Apr. 1, 2015”. For example, the image having the image ID 10000 is captured at “10:00:00”, and it can be understood that the feature is “aaa”.

In the example of FIG. 2, the identification information “capturing location” is a name representing a location such as a store name, but the “capturing location” may be information other than the name but capable of identifying a location, such as, e.g., a latitude and a longitude, address, and the like. The identification information is not limited to the identification information shown in FIG. 2. As long as the identification information is valid information for identifying the image, appropriate information is set as the identification information.

The identification information stored in the first storage unit 20 may be information generated by an imaging device such as a camera or information generated by an image recording device 200 analyzing the first image.

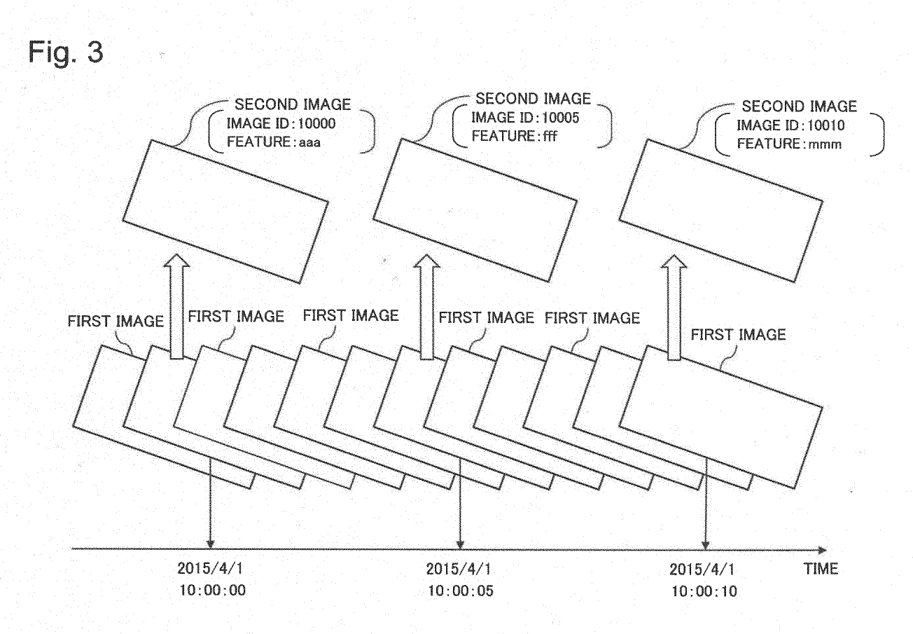

The control unit 21 has a function of obtaining a first image from the first storage unit 20 and generating a second image (digest image) based on the obtained first image. The second image is an image obtained by executing any one of or both of: processing for reducing the size of the first image; and processing for extracting an image satisfying a given extraction condition from among multiple first images. FIG. 3 is a diagram schematically illustrating a specific example in which the control unit 21 extracts an image from multiple first images stored in the first storage unit 20, thereby generating a second image. In the example of FIG. 3, three first images having image IDs “10000”, “10005”, “10010” are extracted as second images.

As described above, the second image may be an image extracted based on the extraction condition from multiple first images. Alternatively, the second image may be an image obtained by reducing the resolution of all or a part of the first image, or an image generated by cropping a part of the pixels constituting the first image. Further, the second image may be an image generated by compressing the color information of the first image. As described above, there are various methods for generating the second image. Among these methods, an appropriate method may be adopted in view of, for example, the resolution of the first image and the time interval of capturing, and the like.

Further, the control unit 21 has a function of associating, with the generated second image, identification information based on identification information associated with the first image serving as the basis of the generated second image (hereinafter, such first image may also be referred to as a base image). In the case where multiple pieces of identification information are associated with the base image (first image), all of the pieces of identification information of the base image may be associated with the second image, or some of pieces of identification information selected from among the pieces of identification information of the base image may be associated with second image. When some of pieces of identification information are selected from among the pieces of identification information of the base image may be associated with second image, the pieces of identification information are selected in view of the information used in the processing executed by the detection device 400.

The first transmission unit 22 has a function of transmitting, to the storage 300, the generated second image and the identification information about the second image in such a manner that the generated second image and the identification information about the second image are associated with each other.

The storage 300 includes a second storage unit 30. The second storage unit 30 stores the second image and the identification information transmitted from the first transmission unit 22 of the image recording device 200 in such a manner that the second image and the identification information are associated with each other.

The detection device 400 includes an identification unit 40 and a detection unit 41. The detection device 400 has a function of retrieving the second images and the identification information from the second storage unit 30 of the storage 300 at a point in time defined in advance. The point in time may be on every time interval defined in advance, or it may be a point in time when the size of the second images stored in the second storage unit 30 reaches a threshold value, or a point in time when an instruction is given by a user. When the retrieving operation is performed at a point in time based on the size of the second images stored in the second storage unit 30, for example, a notification informing that the size of the second images reaches the threshold value is transmitted from the storage 300 to the detection device 400.

The detection unit 41 has a function of detecting (searching) a second image satisfying the given search condition from among the second images obtained from the second storage unit 30. The search condition is a narrow-down condition for narrowing down the second images obtained from the second storage unit 30, and is set by the user of the image processing system 100 or the like as necessary. To be more precise, for example, the search condition is a condition based on information that identifies a person such as a missing person or a suspect of a crime. The search condition may be a condition based on information for identifying things such as dangerous goods. The information that identifies a person includes information such as the features of a face that can identify an individual, walking style, gender, age, hair color, height, and the like. Further, the information for identifying an object includes information such as a feature of a shape, color, size, and the like. These pieces of information can be represented by information obtained by making luminance information, color information (frequency information), and the like into numerical values. The narrow-down search condition for narrowing down the second images may use date and time when image is captured and information about location. The search condition may be a condition based on a combination of multiple pieces of information.

The identification unit 40 has a function of generating a search condition of a first image by using the identification information associated with the second image (narrowed down) detected by the detection unit 41. The search condition of the first image can also be said to be a condition obtained by rewriting the search condition used by the detection unit 41 by using the identification information.

A specific example of the search condition generated by the identification unit 40 will be described below.

For example, it is assumed that the search condition generated by the identification unit 40 is a search condition using “capturing date” and “capturing time” which are identification information associated with the second image. In this case, the identification unit 40 adopts, as the search condition, a condition having a margin for the “capturing date” and the “capturing time” which are identification information associated with the second image detected by the detection unit 41. For example, it is assumed that the detection unit 41 detects (searches) the second image (image ID: 10005) shown in FIG. 3. The capturing date and time depending on the identification information of this detected second image (image ID: 10005) is 10:00:5 on Apr. 1, 2015. The identification unit 40 generates, as the search condition, a condition allowing a time width (±3 seconds in this case) previously given by the user, the system designer, and the like, for the capturing date and time (i.e., condition that the capturing date and time is 10:00:2 to 10:00:8 on Apr. 1, 2015).

In another example, it is assumed that the search condition generated by the identification unit 40 is a search condition using the “capturing location” which is the identification information associated with the second image. In this case, the identification unit 40 may adopt the “capturing location” associated with the second image as the search condition, or may adopt a condition obtained by adding information for expanding the search range to the “capturing location” as the search condition. For example, it is assumed that the second image (image ID: 10000) shown in FIG. 3 is detected by the detection unit 41. The “capturing location” which is the identification information of this detected second image (image ID: 10000) is a store A as shown in FIG. 2. The identification unit 40 may adopt the “store A” (i.e., the condition that the capturing location is the store A) as the search condition. Alternatively, the identification unit 40 adopts a condition (i.e., a condition that the capturing location is within 6 kilometers from the store A) obtained by adding information for expanding the search range given by the user, the system designer, and the similar person (within 6 kilometers in this case) to the “store A” as the search condition.

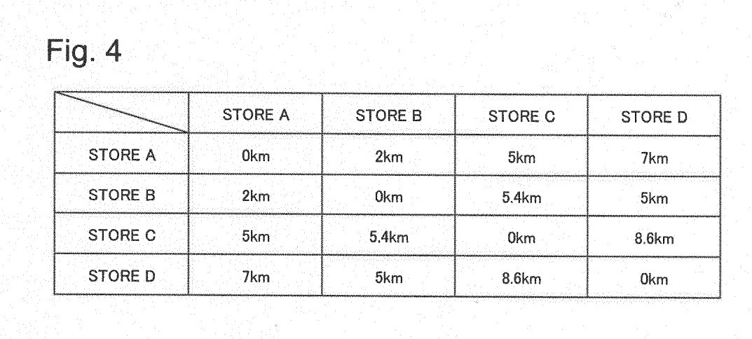

This search condition preferably clarifies the search item more clearly. In this case, the detection device 400 is given information about the distances between stores as shown in FIG. 4. Then, the identification unit 40 uses this information to detect the stores within 6 kilometers from the store A (i.e., the store A, the store B, and the store C). In addition, the identification unit 40 replaces the search condition that the capturing location is within 6 km from the store A, with the search condition that the capturing location is the store A, the store B, and the store C.

Further, in another example, it is assumed that the search condition generated by the identification unit 40 is a search condition using a “feature” which is identification information associated with the second image. The “feature” is quantified information obtained by quantifying information characterizing a person or a thing. For example, information obtained by quantifying luminance information, color information (frequency information), and another information corresponds to the feature. There are various methods for calculating the feature, and, in this case, the feature is calculated by an appropriate method.

When using the feature, the identification unit 40 adopts, as the search condition, a condition obtained by adding information for expanding the search range to the “feature” which is the identification information associated with the second image detected by the detection unit 41. For example, it is assumed that the “feature” which is the identification information about the second image (image ID: 10005) detected by the detection unit 41 is “fff” as shown in FIG. 3 (f is a positive integer in this case). The identification unit 40 makes the feature obtained by changing a part of the feature “fff” as information for expanding the search range. For example, the identification unit 40 generates feature quantities “ffX”, “fXf”, “Xff” (X is any given positive integer) as information enlarging the search range, and adopts, as the search condition, the generated feature quantities and the feature “fff”.

Furthermore, as another example, the search condition generated by the identification unit 40 is assumed to be the search condition using “imaging device ID”, “capturing date”, and “capturing time” which are the identification information associated with the second image. In this case, the identification unit 40 adopts, as the search condition, a condition allowing a time width depending on the “imaging device ID” for the “capturing date” and the “capturing time” which are the identification information associated with the second image detected by the detection unit 41. For example, it is assumed that the detection unit 41 detects (searches) the second image (image ID: 10005) shown in FIG. 3. The capturing date and time depending on the identification information of this detected second image (image ID: 10005) is 10:00:05 on Apr. 1, 2015. The “imaging device ID” which is the identification information about the detected second image is A1.

For the imaging device ID: “A1”, the information about a time width “up to 5 seconds after the capturing time” is set. For the imaging device ID: “A2”, a time width information “3 seconds before and after capturing time” is set. In this manner, the information about the time width that is set for each imaging device ID is given to the detection device 400.

The identification unit 40 detects information about the time width (i.e., “up to 5 seconds after the capturing time”) depending on the imaging device ID: “A1” which is the identification information associated with the second image detected by the detection unit 41. Then, the identification unit 40 generates, as the search condition, a condition obtained by giving the time width to the capturing date and time based on the identification information associated with the second image. More specifically, the search condition in this case is a condition that the capturing date and time is 10:00:05 on Apr. 1, 2015 to 10:00:10 on Apr. 1, 2015.

Furthermore, as another example, not only the information about the time width but also information about another imaging device ID may be associated with the “imaging device ID” which is identification information. For example, not only the information about the time width (i.e., “up to 5 seconds after capturing time”) but also another imaging device ID: “A2” are associated with imaging device ID: “A1”. In this case, the identification unit 40 generates, as the search condition, a condition indicating the images captured by the imaging device ID: “A1” and the images captured by the imaging device ID: “A2” and of which capturing date and time is 10:00:05 on Apr. 1, 2015 to 10:00:10 on Apr. 1, 2015.

As described above, the search condition generated by the identification unit 40 is transmitted to the image recording device 200.

The obtainment unit 23 of the image recording device 200 has a function of collating the search condition transmitted from the identification unit 40 of the detection device 400 with the identification information about the first image stored in the first storage unit 20. In addition, the obtainment unit 23 has a function of obtaining the first image associated with the identification information from the first storage unit 20 when the identification information corresponding to the search condition is present in the first storage unit 20.

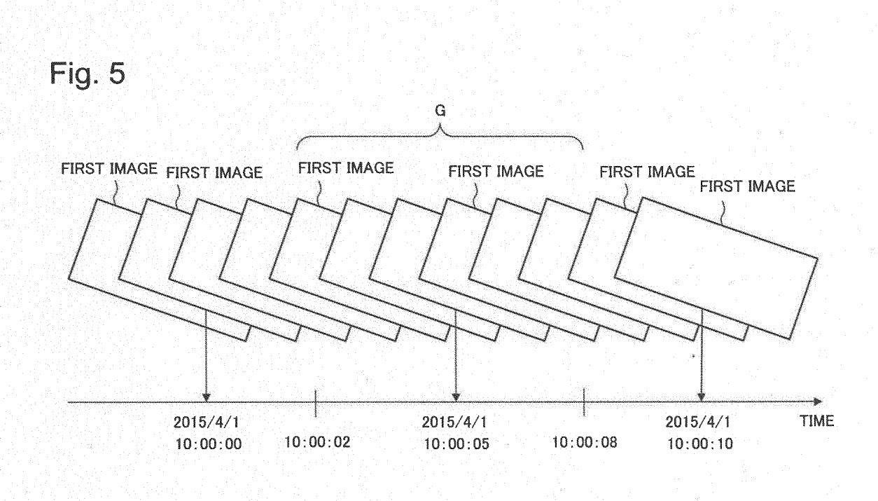

More specifically, for example, it is assumed that the search condition is a condition that the capturing date and time is 10:00:02 to 10:00:08 on Apr. 1, 2015. In this case, the obtainment unit 23 obtains the first image within a range G shown in FIG. 5 corresponding to the search condition based on the “capturing date” and the “capturing time” which are the identification information associated with the first image. Thus, for example, the user can obtain the first image in a time zone (i.e., an image captured by a monitor camera or the like) in which there is a high chance that the target object for which the user is looking has been captured.

For example, it is assumed that the search condition is a condition indicating stores within 6 kilometers from the store A (i.e., store A, store B, and store C). In this case, the obtainment unit 23 obtains the first image corresponding to the search condition based on the “capturing location” which is the identification information associated with the first image. Therefore, for example, the user can get the first image captured at the location where there is a high chance that the target object the user is looking for is captured (i.e., the image captured by the monitor camera and the like).

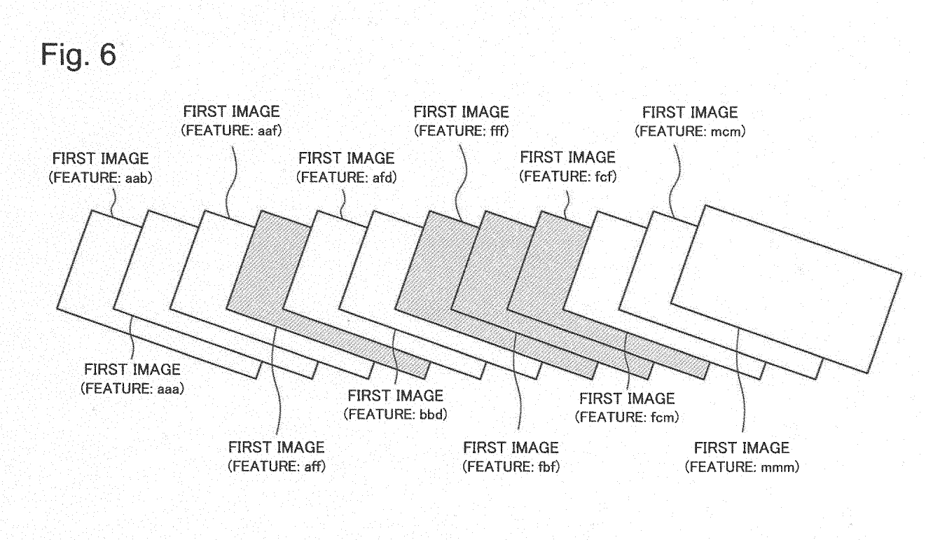

Further, for example, it is assumed that the search condition is a condition that the feature is “fff”, “ffX”, “fXf”, “Xff”. In this case, the obtainment unit 23 obtains the first image hatched in FIG. 6 corresponding to the search condition based on the “feature” which is the identification information associated with the first image. As a result, for example, the user can get the first image (i.e., the image captured by the monitor camera and the like) in which the target object or an object similar to the target object is captured.

Further, it is assumed that the search condition is a condition indicating the images captured by the imaging device ID: “A1” and the images captured by the imaging device ID: “A2” and of which capturing date and time is 10:00:05 on Apr. 1, 2015 to 10:00:10 on Apr. 1, 2015. In this case, the obtainment unit 23 obtains the first image corresponding to the search condition based on the “imaging device ID”, the “capturing date”, and the “capturing time” which are identification information associated with the first image. As a result, for example, the user can get the first image captured at the location in the time zone where there is a high chance that the target object for which the user is looking is captured (i.e., the image captured by the monitor camera and the like).

As described above, the first image obtained by the obtainment unit 23 may be displayed on a display device connected to the image recording device 200, or may be transmitted from the image recording device 200 to the user terminal of a transmission destination defined in advance.

The image processing system 100 according to the first example embodiment is configured as described above. As a result, the image processing system 100 according to the first example embodiment can achieve the following effects: the image processing system 100 according to the first example embodiment obtains the second image (digest image) by performing any one of or both of processing of reducing the size of the first image and processing of extracting an image corresponding to a given extraction condition from multiple first images. Then, the image processing system 100 detects an image corresponding to the search condition from the second image. Therefore, the image processing system 100 has less processing load than detecting an image corresponding to the search condition from the first images, then the image processing system 100 can perform the detection processing in a shorter period of time, and can improve the detection accuracy.

Further, the image processing system 100 generates the search condition for searching the first image using the identification information associated with the second image corresponding to the search condition, and searches the first image by collating the generated search condition and identification information. Therefore, as compared with performing search processing for, e.g., making a determination as to whether there is a first image corresponding to the search condition with the image processing, the image processing system 100 can reduce the load of the search processing, and can perform the search processing in a shorter period of time.

Further, in the image processing system 100, the second image is transmitted from the image recording device 200 to the storage 300, instead of transmitting the first image. Therefore, in the image processing system 100, the amount of communication between the image recording device 200 and the storage 300 is less than the amount of communication when all the first images are transmitted from the image recording device 200 to the storage 300. Therefore, the image processing system 100 can achieve the effect that it is not necessary to adopt a high-speed and large-capacity information communication network for communication between the image recording device 200 and the storage 300.

As described above, the image processing system 100 according to the first example embodiment can reduce the processing time, and can suppress the cost of the system construction, but still the image processing system 100 according to the first example embodiment is more likely to be able to successfully extract (search) the first image including the target object of the search that matches the user's need.

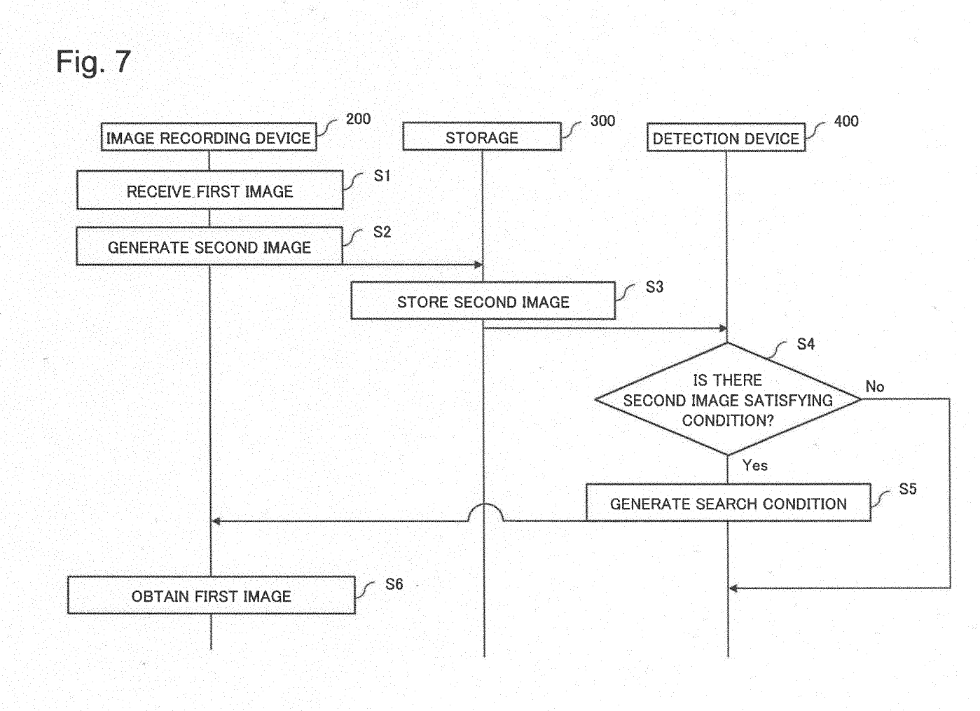

Hereinafter, an example of an operation of the image processing system 100 of the first example embodiment will be explained with reference to FIG. 7. FIG. 7 is a sequence diagram illustrating an example of an operation of the image processing system 100 according to the first example embodiment.

For example when the image recording device 200 receives the image (the first image) captured by the imaging device (step S1 in FIG. 7), the image recording device 200 associates the identification information with the received first image and stores the first image and the identification information into the first storage unit 20.

The control unit 21 of the image recording device 200 obtains the first image and the identification information stored in the first storage unit 20. Then, the control unit 21 generates the second image by executing one or both of the processing for reducing the size of the first image obtained and the processing for extracting the image based on the extraction condition from the multiple first images (step S2). Further, the control unit 21 determines the identification information for identifying the second image based on the identification information associated with the first image (the base image) which is the basis of the generated second image. Then, the first transmission unit 22 transmits the generated second image and the identification information thereof to the storage 300 in such a manner the generated second image and the identification information thereof are associated with each other.

The second storage unit 30 of the storage 300 stores the second image and the identification information received from the first transmission unit 22 in such a manner that the second image and the identification information are associated with each other (step S3).

In the detection device 400, the detection unit 41 determines whether there is the second image corresponding to the given search condition from among the second images obtained from the second storage unit 30 of the storage 300 (step S4). Then, when the detection unit 41 determines that there is no second image corresponding to the search condition, the detection device 400 terminates the processing and enters into a standby state in preparation for subsequent processing. On the other hand, when the detection unit 41 determines that there is the second image corresponding to the search condition, the identification unit 40 generates the search condition using the identification information associated with the second image corresponding to the search condition (step S5). The generated search condition is transmitted to the image recording device 200.

Then, when the obtainment unit 23 of the image recording device 200 receives the search condition from the identification unit 40 of the detection device 400, the obtainment unit 23 of the image recording device 200 collates the received search condition with the identification information stored in the first storage unit 20. When the obtainment unit 23 determines that there is identification information corresponding to the search condition are a result of collation, the obtainment unit 23 obtains the first image associated with the identification information from the first storage unit 20 (step S6).

With such processing, the image processing system 100 according to the first example embodiment can reduce the processing time, and can suppress the cost of the system construction, and in addition, the image processing system 100 according to the first example embodiment is more likely to be able to successfully extract (search) the first image including the target object of the search that matches the user's need.

### Second Example Embodiment

The second example embodiment according to the present invention will be described below. In the description of the second example embodiment, the same reference signs are given to the same name portions as the constituent portions constituting the image processing system according to the first example embodiment, and redundant description about the common portions will be omitted.

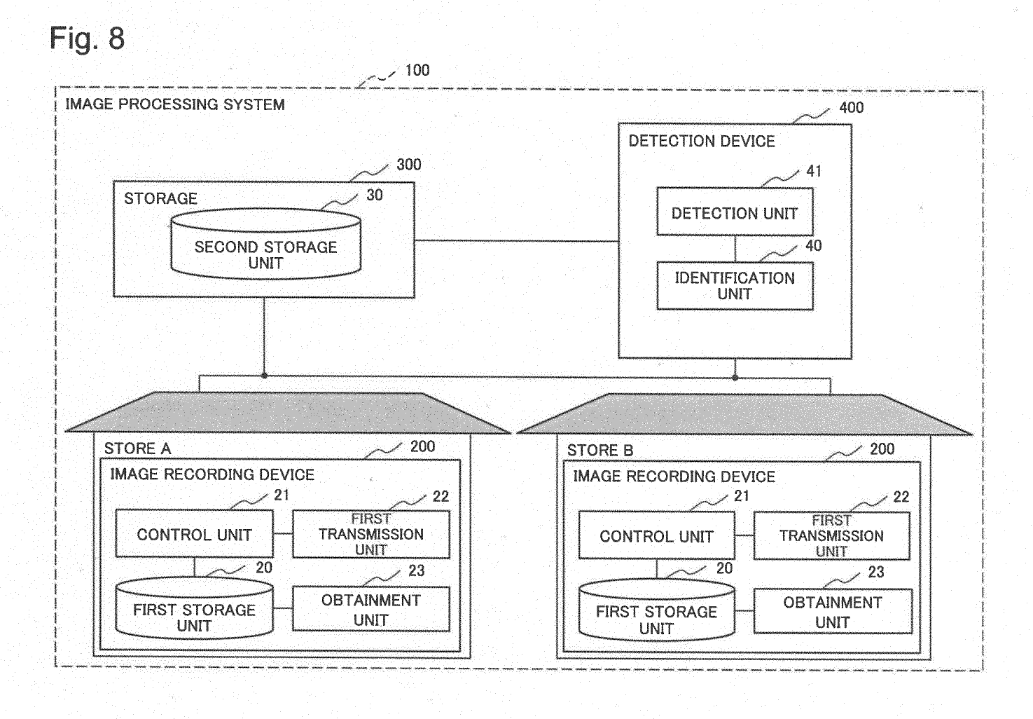

FIG. 8 is a simplified block diagram illustrating a configuration of the image processing system according to the second example embodiment. In the second example embodiment, the image processing system 100 includes multiple image recording devices 200, and each image recording device 200 is installed in association with a different monitor area (store A and store B in the example of FIG. 8). More specifically, in the example of FIG. 8, the imaging device (not shown) such as the monitor camera is installed in each site of the stores A and B, and the insides of the sites of the stores A and B is defined as monitor areas. The image recording device 200 is installed in each of the stores A and B, and the image recording device 200 is connected to the imaging device in each of the stores A and B.

In FIG. 8, the image recording devices 200 are installed in two stores, but the number of stores in which the image recording devices 200 are installed is not limited.

In the second example embodiment, at least information about “capturing location” is associated with the second image as identification information. The identification unit 40 of the detection device 400 transmits the search condition of the generated first image to the image recording device 200 of the transmission destination detected (determined) from the information about the “capturing location” included in the identification information.

The configuration of the image processing system 100 according to this second example embodiment other than the configuration described above is the same as the image processing system 100 according to the first example embodiment.

Since the image processing system 100 according to the second example embodiment has the same configuration as the image processing system 100 according to the first example embodiment, the same effects as the first example embodiment can be obtained in the second example embodiment. In the second example embodiment, the storage 300 and the detection device 400 are shared by multiple image recording devices 200. Therefore, the image processing system 100 according to the second example embodiment can more greatly simplify the device arranged in each monitor area than the configuration in which the image recording device 200, the storage 300, and the detection device 400 are made into a unit (individual devices are combined to be a unit). Therefore, for example, the image processing system 100 according to the second example embodiment can be more easily introduced in each store than the configuration in which the image recording device 200, the storage 300, and the detection device 400 are made into a unit

### Third Example Embodiment

The third example embodiment recited in the present invention will be described below. In the description of the third example embodiment, the same reference signs are given to the same name portions as the constituent portions constituting the image processing system according to the first or second example embodiment, and redundant description about the common portions will be omitted.

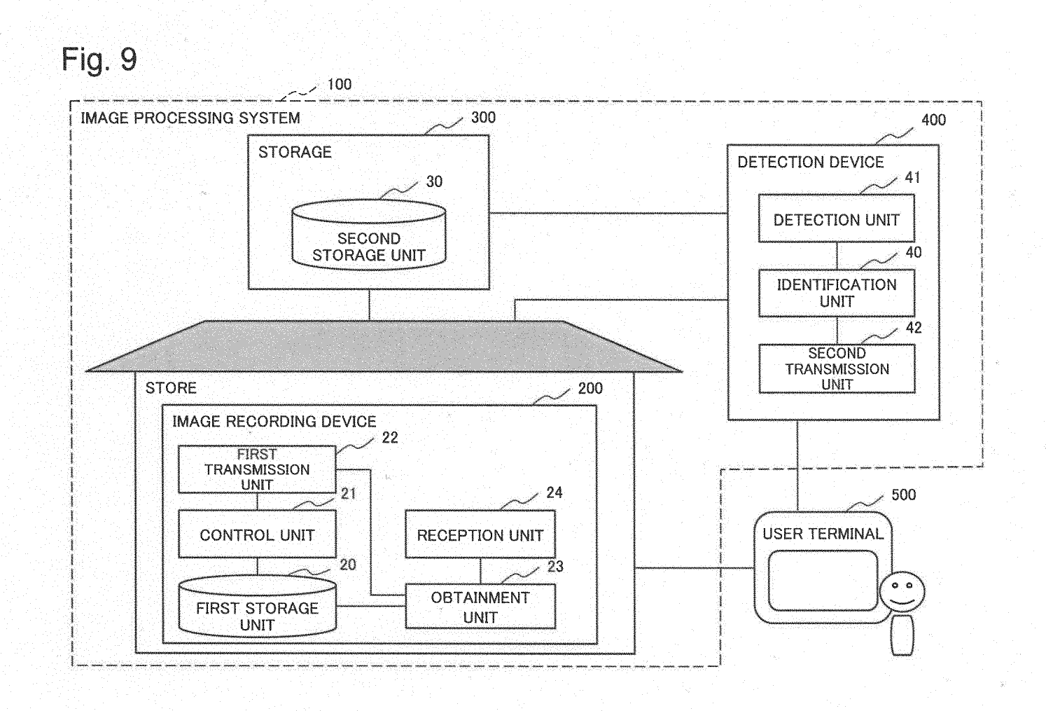

FIG. 9 is a simplified block diagram illustrating a configuration of the image processing system according to the third example embodiment. An image processing system 100 according to the third example embodiment has not only the configuration of the image processing system 100 according to the first example embodiment or the second example embodiment but also a configuration that enables the search condition of the first image to be designated by a user terminal 500. In this case, the user terminal 500 is not particularly limited as long as the user terminal 500 has a communication function, a display function, and an information input function.

More specifically, in the third example embodiment, the detection device 400 further includes a second transmission unit 42 in addition to the identification unit 40 and the detection unit 41. The image processing system 100 according to the third example embodiment has a configuration capable of selecting any one of, for example, an automatic generation mode and a manual generation mode with respecting to generation of the search condition of the first image. When the automatic generation mode is selected, the identification unit 40 of the detection device 400 generates the search condition of the first image similarly to the first example embodiment or the second example embodiment. When the manual generation mode is selected, the second transmission unit 42 transmits the second image detected (searched) by the detection unit 41 and the identification information thereof to the user terminal 500. The communication method between the second transmission unit 42 and the user terminal 500 is not limited, and an appropriate communication method may be adopted.

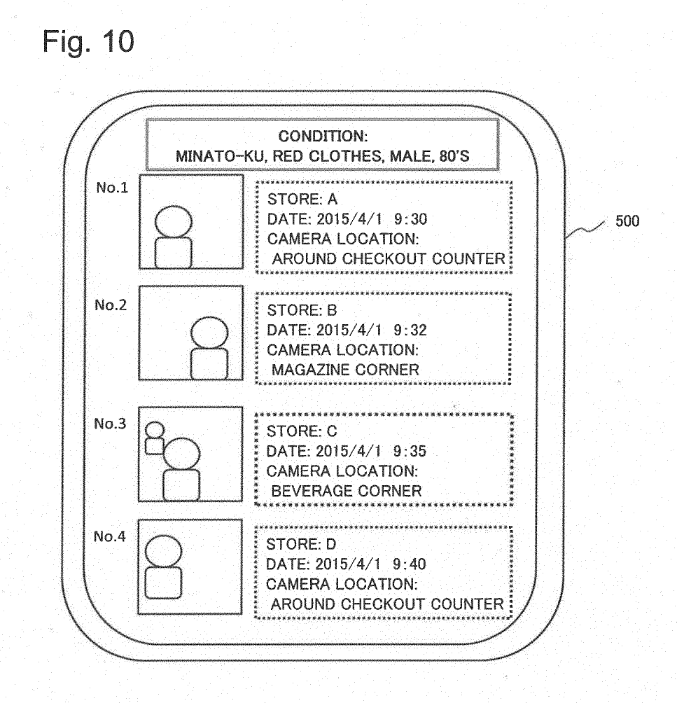

In image processing system 100 according to the third example embodiment, for example, the user terminal 500 displays the second image and the identification information on the display device when the user terminal 500 receives the second image and the identification information. A specific example of the second image and the identification information displayed on the display device of the user terminal 500 is shown in FIG. 10. When the identification information which is the search condition of the first image is designated by the user who sees such display, the designated identification information is transmitted from the user terminal 500 to the image recording device 200. When the second image is designated by the user, the identification information associated with that second image is transmitted from user terminal 500 to the image recording device 200 as the search condition of the first image. The display mode of the user terminal 500 is not limited to the example of FIG. 10.

The image recording device 200 further includes a reception unit 24 in addition to the configuration of the first example embodiment or the second example embodiment. The reception unit 24 receives the identification information transmitted by the user terminal 500 as the search condition of the first image. When the receiving unit 24 receives the search condition of the first image, the obtainment unit 23 obtains the first image from the first storage unit 20 based on the search condition.

The configuration of the image processing system 100 according to the third example embodiment other than the configuration described above is the same as the first example embodiment or the second example embodiment. The image recording device 200 may further have a configuration for transmitting the first image obtained by the obtainment unit 23 toward the user terminal that transmitted the search condition.

The image processing system 100 according to the third example embodiment has a configuration in which the user can designate the search condition of the first image. As a result, the image processing system 100 according to the third example embodiment can improve the usability for the user.

In the third example embodiment, since the second images are narrowed down by the detection unit 41 and further narrowed down by the user, the processing load in the obtainment unit 23 can be reduced more greatly. Furthermore, when the configuration for transmitting the first image obtained by the obtainment unit 23 to the user terminal is provided, the size of the first image transmitted from the image recording device 200 to the user terminal can be reduced.

In the above example, any one of the automatic generation mode and the manual generation mode of the search condition of the first image is selected, but, in addition, an automatic plus manual generation mode may be provided and the automatic plus manual generation mode may be configured to be selectable. When the automatic plus manual generation mode is selected, for example, first, processing in the automatic generation mode as described above is executed, and the first image obtained by the obtainment unit 23 is presented to the user. Thereafter, the processing in the manual generation mode is executed, and the first image obtained by the processing in the manual generation mode is presented to the user.

### Fourth Example Embodiment

The fourth example embodiment according to the present invention will be described below. In the description of the fourth example embodiment, the same reference signs are given to the same name portions as the constituent portions constituting the image processing system according to the first, second, or third example embodiment, and redundant description about the common portions will be omitted.

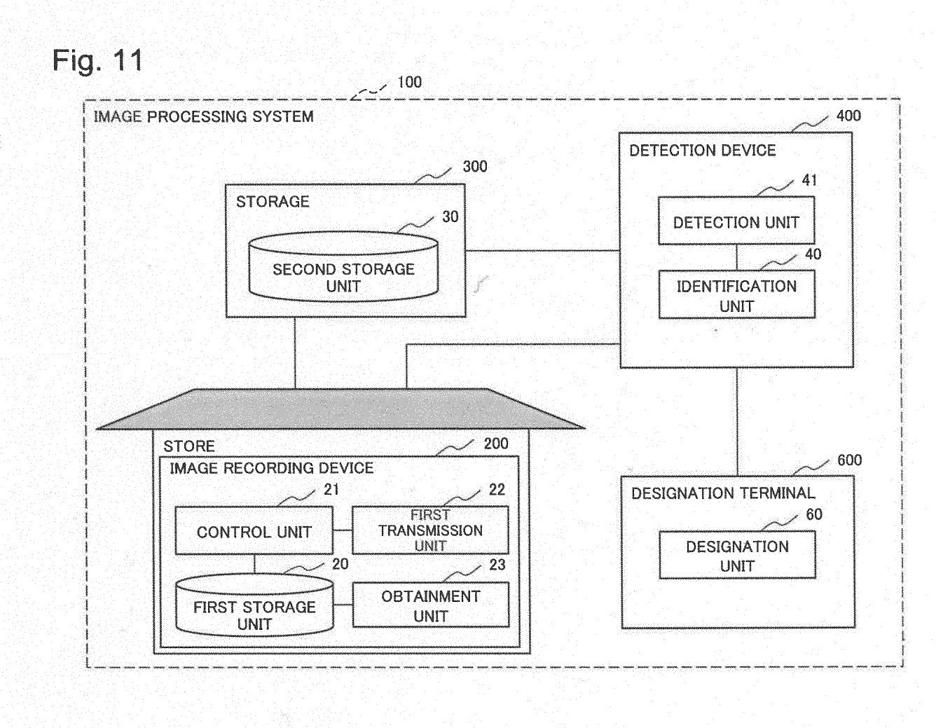

FIG. 11 is a simplified block diagram illustrating a configuration of the image processing system according to the fourth example embodiment. The image processing system 100 according to the fourth example embodiment includes a designation terminal 600 having a designation unit 60 in addition to the configuration of the image processing system 100 according to the first, second, or third example embodiment. In FIG. 11, only one image recording device 200 is shown, but as with the second example embodiment, multiple image recording devices 200 may be provided.

The designation unit 60 has a function of receiving, from the user, the search item of the search condition with which the detection unit 41 narrows down the second images, and transmitting the received search item to the detection device 400.

The detection unit 41 adds the search item received from the designation unit 60 to the search condition used for the search processing for narrowing down the second images, and performs the search processing of the second image based on the search condition to which this search item was added.

The configuration of the image processing system 100 according to the fourth example embodiment other than the configuration described above is the same as the configuration of the image processing system 100 according to the first, second, or third example embodiment.

The image processing system 100 according to the fourth example embodiment has a configuration capable of more easily satisfying user's needs in the search processing of the second image. Therefore, the image processing system 100 can provide the first image more suitable to the needs of the user.

### Fifth Example Embodiment

The fifth example embodiment recited in the present invention will be described below. In the description of the fifth example embodiment, the same reference signs are given to the same name portions as the constituent portions constituting the image processing system according to the first to fourth example embodiments, and redundant description about the common portions will be omitted.

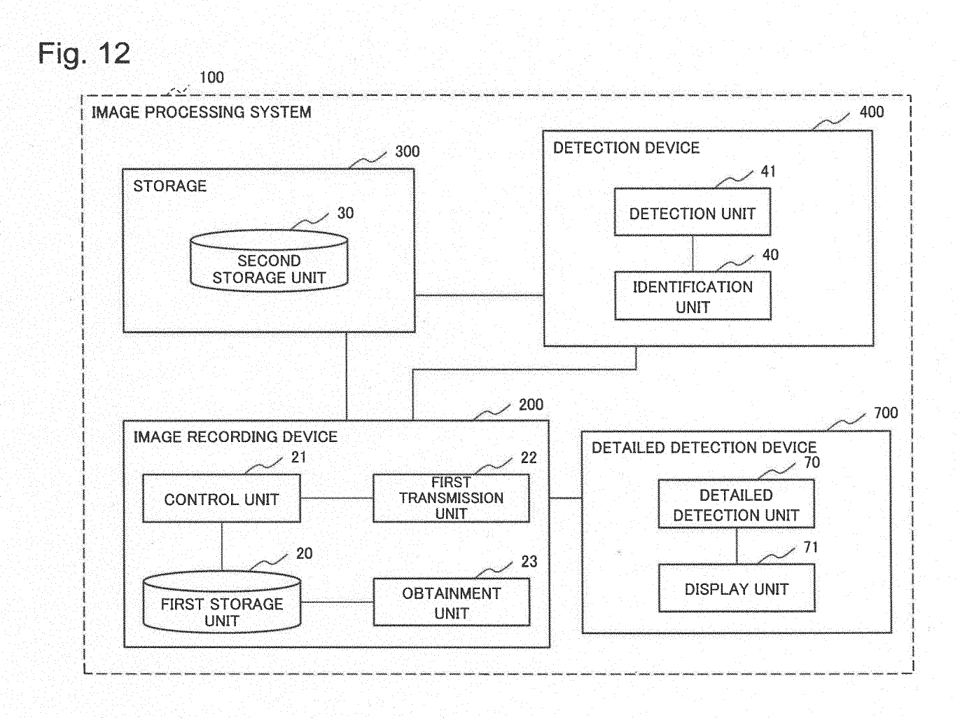

FIG. 12 is a simplified block diagram illustrating a configuration of an image processing system according to the fifth example embodiment recited in the present invention. The image processing system 100 according to the fifth example embodiment has a detailed detection device 700 in addition to the configuration of the image processing system 100 according to any one of the first to fourth example embodiments. In the fifth example embodiment, the first transmission unit 22 of the image recording device 200 transmits the first image obtained by the obtainment unit 23 to the detailed detection device 700. The point in time when the obtainment unit 23 transmits the first image to the detailed detection device 700 may be with each time interval that has been set, or may be a point in time when the obtainment unit 23 obtains the first image, or may be a point in time when the user gives an instruction.

The detailed detection device 700 includes a detailed detection unit 70 and a display unit 71. The detailed detection unit 70 has a function of detecting (searching) the first image satisfying a preset detailed search condition from the first images received from the image recording device 200. The point in time when the detailed detection unit 70 performs the detection processing may with each time interval that has been set, or may be a point in time when the size of the first images stored in the storage unit (not shown) of the detailed detection device 700 has reached a threshold value, or may be a point in time when the user gives an instruction.

The detailed search condition used by the detailed detection unit 70 for the processing is the same content as the search condition used by the detection unit 41 of the detection device 400 for the search processing of the second image, or may be a more detailed (limited) condition. The detailed search condition can be set by the system designer, the user, and the like, as necessary. This will be explained more specifically. For example, when the search condition used by the detection unit 41 is a condition of “wearing a red hat”, the detailed search condition is “wearing a red hat” and “having a face similar to the person A designated”. For example, when the search condition used by the detection unit 41 is a condition that “the degree of similarity with the person A is 60% or more”, the detailed search condition is a condition that “the degree of similarity with the person A is 90% or more”.

The display unit 71 has a function of displaying the search result given by the detailed detection unit 70 on a display device or the like. The display form of the search result on the display unit 71 may be set as necessary, and is not limited. If there is no first image corresponding to the detailed search condition, the display unit 71 may display a comment such as “there is no image that matches the condition” or may display all the first images searched in the search processing.

The configuration of the image processing system 100 according to the fifth example embodiment other than the configuration described above is similar to that of the image processing system 100 according to the first to fourth example embodiments. The image processing system 100 according to the fifth example embodiment can provide the first image more accurately and more suited to the needs of the user. More specifically, the detection unit 41 searches the second image corresponding to the search condition from the second images (digest images), and the obtainment unit 23 searches for the first image based on the search condition generated using the search result. The image processing system 100 according to the fifth example embodiment performs search processing with the detailed detection unit 70 on the first images (in other words, the narrowed down first images) obtained by the obtainment unit 23 as described above. Therefore, the first images can be further narrowed-down according to the search condition.

### Sixth Example Embodiment

The sixth example embodiment recited in the present invention is explained below.

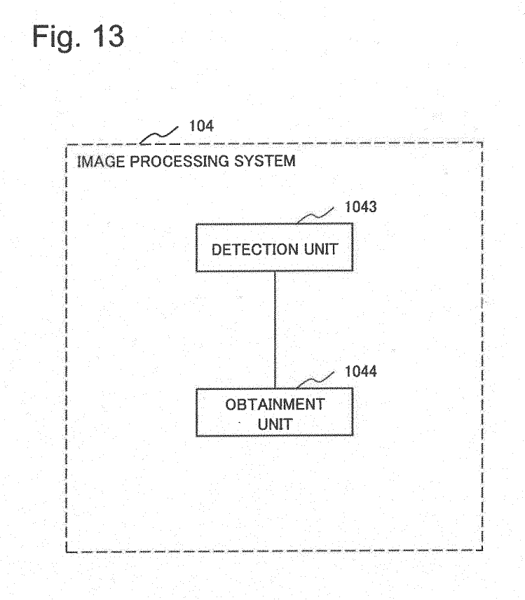

FIG. 13 is a simplified block diagram illustrating a configuration of the image processing system according to the sixth example embodiment. An image processing system 104 according to the sixth example embodiment includes a detection unit 1043 and an obtainment unit 1044. The detection unit 1043 has a function of detecting (searching) a second image satisfying a search condition defined in advance. The obtainment unit 1044 has a function of obtaining a first image depending on the detected second image.

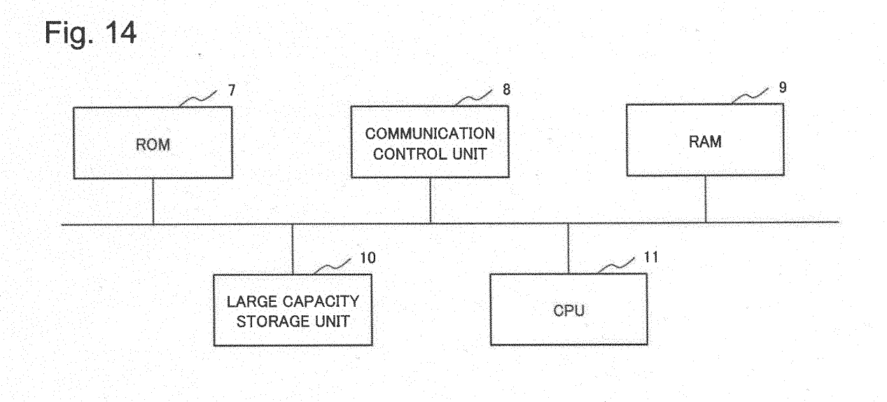

FIG. 14 is a simplified block diagram illustrating a hardware configuration realizing the image processing system 104 according to the sixth example embodiment. More specifically, the image processing system 104 includes a ROM (Read-Only Memory) 7, a communication control unit 8, a RAM (Random Access Memory) 9, a large capacity storage unit 10, and a CPU (Central Processing Unit) 11.

The CPU 11 is a processor for arithmetic control and realizes the functions of the detection unit 1043 and the obtainment unit 1044 by executing a program. The ROM 7 is a storage medium for storing fixed data such as initial data and a computer program (program). The communication control unit 8 has a configuration for controlling communication with an external device. The RAM 9 is a random access memory used by the CPU 11 as a temporary storage work area. A capacity for storing various kinds of data required for realizing the embodiments is secured in the RAM 9. The large capacity storage unit 10 is a nonvolatile storage unit, and stores data such as databases required for realizing the embodiments, application programs executed by the CPU 11, and the like.

The image recording device 200 and the detection device 400 in the image processing system according to the first to the fifth example embodiments also have the hardware configuration shown in FIG. 14 to realize the functions as described above.

### Seventh Example Embodiment

The seventh example embodiment recited in the present invention will be described below. In the description of the seventh example embodiment, the same reference signs are given to the same name portions as the constituent portions constituting the image processing system according to the first to sixth example embodiments, and redundant description about the common portions will be omitted.

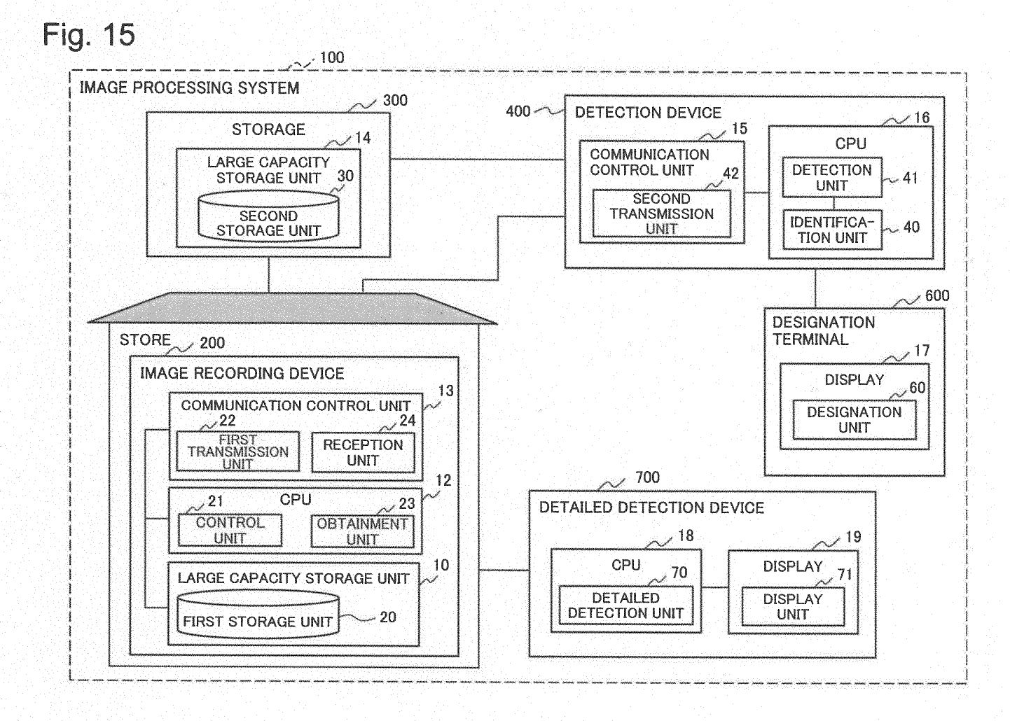

FIG. 15 is a simplified block diagram illustrating a configuration of the image processing system according to the seventh example embodiment. More specifically, in the image processing system 100 of the seventh example embodiment, the first storage unit 20 of the image recording device 200 is realized by a large capacity storage unit 10 (see FIG. 14). The control unit 21 and the obtainment unit 23 are realized by a CPU 12 (corresponding to the CPU 11 in FIG. 14). The first transmission unit 22 and the reception unit 24 are realized by a communication control unit 13 (corresponding to the communication control unit 8 in FIG. 14).

The second storage unit 30 of the storage 300 is realized by a large capacity storage unit 14 (corresponding to the large capacity storage unit 10 in FIG. 14). The second transmission unit 42 is realized by a communication control unit 15 (corresponding to the communication control unit 8 in FIG. 14).

The identification unit 40 and detection unit 41 of the detection device 400 are realized by a CPU 16 (corresponding to the CPU 11 in FIG. 14).

The designation unit 60 of the designation terminal 600 is realized by a display 17. Further, the designation unit 60 is realized by a mouse, a keyboard, hard keys of the designation terminal 600, and the like.

The detailed detection unit 70 of the detailed detection device 700 is realized by a CPU 18 (corresponding to CPU 11 in FIG. 14). The display unit 71 is realized by a display 19.

### Eighth Example Embodiment

The eighth example embodiment recited in the present invention will be described below. In the description of the eighth example embodiment, the same reference signs are given to the same name portions as the constituent portions constituting the image processing system according to the first to seventh example embodiment, and redundant description about the common portions will be omitted.

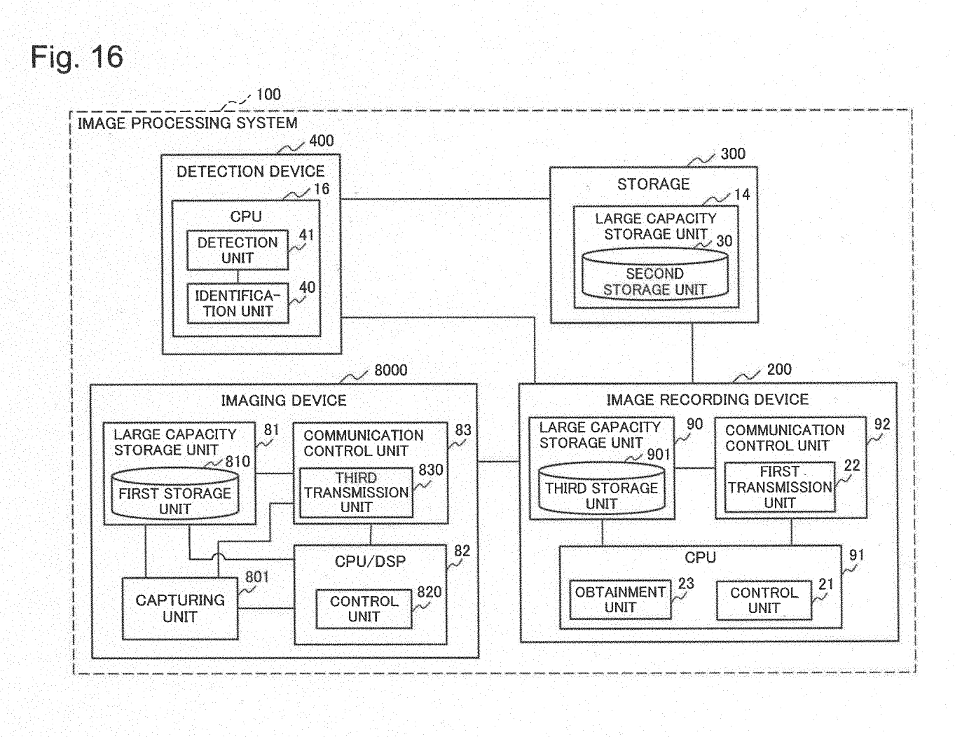

FIG. 16 is a simplified block diagram illustrating a configuration of the image processing system according to the eighth example embodiment. The image processing system 100 according to the eighth example embodiment includes an imaging device 8000 in addition to the configuration of the image processing system 100 according to the first example embodiment.

The imaging device 8000 is an imaging device such as a security camera installed in a store or a facility. The imaging device 8000 includes a capturing unit 801, a first storage unit 810, a control unit 820, and a third transmission unit 830. In the eighth example embodiment, instead of providing the first storage unit in the image recording device 200, the first storage unit is provided as the first storage unit 810 in the imaging device 8000.

More specifically, the capturing unit 801 captures an image in a store and the like and generates the first image. The first storage unit 810 stores the first image generated by the capturing unit 801 in association with the identification information. It is noted that the identification information may be generated by the imaging device or may be generated by another device.

The control unit 820 obtains the first image and the identification information thereof from the first storage unit 810. Then, the control unit 820 generates a third image and a fourth image (generated images) based on the first image. The fourth image is a smaller image than the third image. The third image and the fourth image are obtained as a result of any one of or both of processing of reducing the size of the first image and processing of extracting an image corresponding to a given extraction condition from among multiple first images. More specifically, the third image and the fourth image may be generated by extracting some images from the first image, or may be generated by cropping some of the pixels of the first image. The third image and the fourth image may be generated by reducing the resolution of all or a part of the first image. Furthermore, the third image and the fourth image may be generated by compressing the first image. It is noted that the third image may be a still image generated using a method such as JPEG (Joint Photographic Experts Group) method. The fourth image may be a moving image generated using a method such as H. 264 method. The processing to generate the third image and the processing to generate the fourth image may be similar to each other or may be different from each other.

Further, the control unit 820 determines identification information for identifying the generated third image and fourth image based on the identification information of the first image.

The third transmission unit 830 transmits the third image and the fourth image generated by the control unit 820 to the image recording device 200. At this occasion, the third transmission unit 830 also transmits the identification information for identifying the third image and the identification information for identifying the fourth image to the image recording device 200.

In this case, the image recording device 200 is a device such as an STB (set top box) installed in a store or the like. The image recording device 200 includes the control unit 21, the first transmission unit 22, and the obtainment unit 23, and further includes a third storage unit 901 instead of the first storage unit 20. The third storage unit 901 stores the third image and the fourth image received from the third transmission unit 830 in such a manner that the third image and the fourth image are associated with the identification information thereof.

The control unit 21 has a function of generating the second image based on the third image instead of the first image. More specifically, the control unit 21 generates the second image by performing any one of or both of processing of reducing the size of the third image stored in the third storage unit 901 and processing of extracting an image corresponding to a given extraction condition from multiple first images. More specifically, the control unit 21 generates the second image by reducing the size of the third image. The control unit 21 may generate second images by extracting some images from the third image, or may generate the second image by cropping some of the pixels of the third image. Alternatively, the control unit 21 may generate the second image by lowering the resolution of all or a part of the third image, or may generate the second image by compressing the third image.

The control unit 21 further determines the identification information for identifying the generated second image based on the identification information associated with the third image.

The first transmission unit 22 has a function of transmitting the second image generated by the control unit 21 and the identification information thereof to the storage 300. The storage 300 has the function of storing the second image in the second storage unit 30. This storage 300 is realized by, for example, a cloud server.

The receiving unit 23 of the image recording device 200 has a function of collating the search condition generated using the identification information from the detection device 400 with the identification information associated with the fourth image of the third storage unit 901 when the receiving unit 23 of the image recording device 200 receives the search condition. The obtainment unit 23 has a function of obtaining the fourth image corresponding to the search condition from the third storage unit 901.

The third transmission unit 830 may transmit the third image to the storage 300 rather than the image recording device 200. In this case, the control unit 21 does not perform processing to generate the second image based on the third image (first image). The second storage unit 30 of the storage 300 stores the third image received from the third transmission unit 830 as the second image.

The image processing system 100 according to the eighth example embodiment is realized by a hardware configuration as shown in FIG. 16. For example, the control unit 820 of the imaging device 8000 is realized by a CPU/DSP 82 which is a CPU or a DSP (Digital Signal Processor). The capturing unit 801 is realized by an image sensor such as a CCD (Charge Coupled Device). The first storage unit 810 is realized by a large capacity storage unit 81 such as a RAM (Random Access Memory). The third transmission unit 830 is realized by a communication control unit 83 (communication control unit 8 in FIG. 14).

The third storage unit 901 of the image recording device 200 is realized by a large capacity storage unit 90 (large capacity storage unit 10 in FIG. 14). The obtainment unit 23 and the control unit 21 are realized by a CPU 91 (the CPU 11 in FIG. 14). The first transmission unit 22 is realized by a communication control unit 92 (communication control unit 8 in FIG. 14).

The second storage unit 30 of the storage 300 is realized by a large capacity storage unit 14 (large capacity storage unit 10 in FIG. 14).

The identification unit 40 and the detection unit 41 of the detection device 400 are realized by a CPU 16 (the CPU 11 in FIG. 14).

In the eighth example embodiment, the imaging device 8000 does not transmit the first image, i.e., the captured image, directly to the image recording device 200, and instead, the imaging device 8000 transmits the third image and the fourth image generated based on the first image. The communication amount of the third image and the fourth image between the imaging device 8000 and the image recording device 200 is smaller than the communication amount of the first image. For this reason, the image processing system 100 according to the eighth example embodiment does not require a high-speed network to transmit the image from the imaging device 8000 to the image recording device 200. Therefore, the image processing system achieving a low cost and high speed processing can be provided.

### Other Embodiment

It is noted that the present invention is not limited to the above embodiments, and various embodiments can be adopted. For example, after the obtainment unit 23 of the image recording device 200 obtains the first image, the detection unit 41 may further perform processing to narrow down the first images obtained. For example, it is assumed that a moving image is stored in the first storage unit 20 and a still image extracted from the moving image is stored in the second storage unit 30. In this case, first, the detection unit 41 searches for (detects) a still image corresponding to the search condition (for example, condition using a feature about such as face) from the still images which is the second image stored in the second storage unit 30. Then, the identification unit 40 uses the identification information associated with the second image thus searched to generate the search condition, and when the obtainment unit 23 obtains the first image (moving image) based on the search condition given by the identification unit 40, the first image is transmitted to the detection device 400. Thereafter, the detection unit 41 searches (detects) the first image corresponding to the search condition for the moving image (condition using the feature based on the movement of walking style) from the received first image (moving image).

The search processing of the above first image (moving image) can perform the search using both of the search condition in view of still image and the search condition in view of moving image. Therefore, a person and the like can be searched with a high degree of accuracy.

For example, the search processing of the detection unit 41 as described above may be executed repeatedly by changing the search condition multiple times.

The image processing system 100 according to each embodiment may cooperate with another information management system to improve the performance of information analysis and to increase the speed. For example, the image processing system 100 can analyze purchase behavior of customers by cooperating with a point of sale information management (POS (Point Of Sales)) system. More specifically, first, the detection unit 41 in the image processing system 100 searches (detects) the second image corresponding to the search condition based on the feature representing the person to be searched. How long and in which store the person to be searched has been staying is calculated based on the identification unit 40 based on this search result and the first image obtained in the processing of the obtainment unit 23. This calculation may be performed by the user of the system, or may be performed by a calculating unit (not shown) provided in the image processing system 100.

On the other hand, the image processing system 100 obtains, from the POS system, information about purchase situation, e.g., whether the person to be searched purchased a product, what type of product was purchased, and the like. As a result, the image processing system 100 can obtain the relationship between the period of time for which the person stayed in the store and the purchasing behavior. The POS system has an imaging device. This imaging device is placed in a location that can capture a customer who is checking out. The image processing system 100 uses the captured image of the imaging device. For example, the POS terminal provided in the POS system generates customer's product purchase information based on the information input by a shop clerk or the like. Further, the storage unit of the POS system stores the product purchase information and the feature of the image captured by the imaging device in association with each other. As a result, the POS system can associate the product purchasing information with the person who is captured by the imaging device.

Each constituent element in each embodiment may be realized by cloud computing. For example, the first storage unit 20 may be constituted by a storage unit in a store or a storage unit in an imaging device. The second storage unit 30 may be constituted by a storage in the cloud server. Other constituent elements may also be realized by the cloud server. As a result, the second storage unit 30 can quickly receive the second image and the detection device 400 can process the second image even when the image recording devices 200 are scattered in multiple stores different from each other facilities located in remote places or the like. Therefore, the user can find the situation at multiple locations in a timely manner. Since user can manage multiple images at multiple places through cloud computing, this can save the user a lot of effort in the management of the second images.

Further, in each embodiment, the control unit 21 and the obtainment unit 23 serve as the functions of the image recording device 200, and the identification unit 40 and the detection unit 41 serve as the functions of the detection device 400. However, the control unit 21 and the obtainment unit 23, and the identification unit 40 and the detection unit 41 may be provided as the functions in the same device.

The present invention has been described above while the above-described embodiments are used as typical examples. However, the present invention is not limited to the embodiments described above. More specifically, the present invention can be made into various aspects that can be understood by those skilled in the art within the scope of the present invention.

This application claims the priority based on Japanese Patent Application No. 2015-040141 filed on Mar. 2, 2015, the entire disclosure of which is incorporated herein by reference.

Some or all of the above embodiments may also be described as follows, but are not limited thereto.

(Supplemental Note 1)

An image processing system including:

a detection unit that detects a second image satisfying a first predetermined condition from a second image obtained by reducing a size of a first image; and

an obtainment unit that obtains an image corresponding to the detected second image from the first image or an image generated from the first image.

(Supplemental Note 2)

The image processing system according to Supplemental note 1, further including a detailed detection unit that detects an image satisfying a second predetermined condition from the image obtained by the obtainment unit,

wherein the second predetermined condition is a more detailed condition than the first predetermined condition.

(Supplemental Note 3)

The image processing system according to Supplemental note 1 or Supplemental note 2, wherein the second image is a part of the first image, an image obtained by compressing the first image, or an image of which resolution is lower than the first image.

(Supplemental Note 4)

The image processing system according to any one of Supplemental note 1 to Supplemental note 3, further including:

a second storage unit that associates and stores the second image and identification information for identifying the second image;

a third storage unit that associates and stores an image generated from the first image and the identification information; and

an identification unit that identifies the identification information associated with the second image detected,

wherein the obtainment unit obtains, from the third storage unit, an image associated with the identification information having been identified.

(Supplemental Note 5)

The image processing system according to any one of Supplemental note 1 to Supplemental note 4, further including:

a first storage unit that associates and stores the first image and identification information for identifying the first image;

a second storage unit that associates and stores the identification information associated with at least one of the first images and the second image; and

an identification unit that identifies the identification information associated with the second image detected,

wherein he obtainment unit obtains, from the first storage unit, the first image associated with the identification information having been identified.

(Supplemental Note 6)

The image processing system according to Supplemental note 4 or Supplemental note 5, wherein the identification information is information including at least one of a capturing date and time of an image, a capturing location of the image, an imaging device that has captured the image, or a feature of the image.

(Supplemental Note 7)

The image processing system according to any one of Supplemental note 4 to Supplemental note 6, wherein the identification unit further identifies identification information within an identification condition from the identification information associated with the second image, and

the obtainment unit obtains an image associated with the identification information or identification information within the identification condition.

(Supplemental Note 8)

The image processing system according to any one of Supplemental note 4 to Supplemental note 7, further including:

a second transmission unit that transmits the detected second image to a user terminal; and

a reception unit that receives identification information associated with the second image designated by a user,

wherein the obtainment unit further includes a first transmission unit for obtaining an image associated with the identification information received, and transmitting the obtained image to s user terminal.

(Supplemental Note 9)

The image processing system according to any one of Supplemental note 1 to Supplemental note 8, further including a designation unit that designates the predetermined condition.

(Supplemental Note 10)

The image processing system according to any one of Supplemental note 4 to Supplemental note 6, wherein a capturing date and time of which difference from the capturing date and time associated with the second image is within a particular time is determined to be identification information about the first image.

(Supplemental Note 11)

The image processing system according to any one of Supplemental note 4 to Supplemental note 6, wherein the identification unit determines, as identification information about the first image, a capturing location of which distance from the capturing location associated with the second image is within a predetermined value.

(Supplemental Note 12)

The image processing system according to any one of Supplemental note 4 to Supplemental note 6, wherein the identification unit determines, as identification information about the first image, a feature which is within a particular condition from the feature associated with the second image.

(Supplemental Note 13)

The image processing system according to any one of Supplemental note 1 to Supplemental note 12, wherein the first storage unit stores the first image in a store, and

the second storage unit stores the second image in a cloud server.

(Supplemental Note 14)

An image processing method including:

detecting a second image satisfying a first predetermined condition from a second image obtained by reducing a size of a first image; and

obtaining an image corresponding to the detected second image from the first image or an image generated from the first image.

(Supplemental Note 15)

An image processing program for causing a computer to execute:

detecting a second image satisfying a first predetermined condition from a second image obtained by reducing a size of a first image; and

obtaining an image corresponding to the detected second image from the first image or an image generated from the first image.

### REFERENCE SIGNS LIST

21 control unit
23 obtainment unit
24 reception unit
30 second storage unit
40 identification unit
41 detection unit
60 designation unit
70 detailed detection unit
80 capturing unit
100 image processing system
200 image recording device
300 storage
400 detection device
700 detailed detection device
8000 imaging device

1. An image processing system comprising:
a memory configured to store instructions; and
a processor configured to execute the instructions to:
detect a second image satisfying a search condition from a plurality of second images, the plurality of second images being obtained by performing processing of any one of or both of processing for reducing a size of a first image which is an image to be processed and processing for extracting an image satisfying an extraction condition from among a plurality of first images which are images to be processed;
associate the second image detected with identification information for identifying the second image, and transmit the second image and the identification information to a user terminal;
receive the identification information, the identification information being information in which the second image selected by the user is associated with and information transmitted from the user terminal; and
obtain the first image or a generated image generated from the first image using the identification information received.

2. The image processing system according to claim 1, wherein the processor executes further instruction to
detect, from the image obtained, an image satisfying the search condition or a detailed search condition in which a search item is more detailed than the search condition.

3. The image processing system according to claim 1, wherein the second image is a part of the first image, an image obtained by compressing the first image, or an image of which resolution is lower than the first image.

4. (canceled)

5. The image processing system according to claim 1, wherein the first image is associated with identification information for identifying the first image,
the processor executes further instruction to determine the identification information for identifying the second image satisfying the search condition, based on the identification information associated with the first image which is a basis of the second image
wherein the processor uses the identification information received from the user terminal to obtain the first image or the generated image depending on the second image narrowed down from the second image satisfying the search condition.

6. The image processing system according to claim 5, wherein the identification information is information including at least one of a capturing date and time of an image, a capturing location of the image, an imaging device capturing the image, or a feature of the image.

7. The image processing system according to claim 1, the processor executes further instruction to receive
information about a search item of the search condition designated from an outside,
wherein the processor detects the second image satisfying the search item of the search condition received.

8. An image processing method comprising:
by processor,
detecting a second image satisfying a search condition from a plurality of second images, the plurality of second images being obtained by performing processing of any one of or both of processing for reducing a size of a first image which is an image to be processed and processing for extracting an image satisfying an extraction condition from among a plurality of first images which are images to be processed;
associating the second image detected with identification information for identifying the second image, and transmitting the second image and the identification information to a user terminal;
receiving the identification information, the identification information being information in which the second image selected by the user is associated with and information transmitted from the user terminal; and
obtaining the first image or a generated image generated from the first image using the identification information received.

9. A non-transitory program storage medium storing a processing procedure for causing a processor to execute:
detecting a second image satisfying a search condition from a plurality of second images, the plurality of second images being obtained by performing processing of any one of or both of processing for reducing a size of a first image which is an image to be processed and processing for extracting an image satisfying an extraction condition from among a plurality of first images which are images to be processed;
associating the second image detected with identification information for identifying the second image, and transmitting the second image and the identification information to a user terminal;
receiving the identification information, the identification information being information in which the second image selected by the user is associated with and information transmitted from the user terminal; and
obtaining the first image or a generated image generated from the first image using the identification information received.

10. The image processing system according to claim 2, wherein the second image is a part of the first image, an image obtained by compressing the first image, or an image of which resolution is lower than the first image.

11. The image processing system according to claim 2, wherein the first image is associated with identification information for identifying the first image,
the processor executes further instruction to determine the identification information for identifying the second image satisfying the search condition, based on the identification information associated with the first image which is a basis of the second image;
wherein the processor uses the identification information received from the user terminal to obtain the first image or the generated image depending on the second image narrowed down from the second image satisfying the search condition.

12. The image processing system according to claim 3, wherein the first image is associated with identification information for identifying the first image,
the processor executes further instruction to determine the identification information for identifying the second image satisfying the search condition, based on the identification information associated with the first image which is a basis of the second image;
wherein the processor uses the identification information received from the user terminal to obtain the first image or the generated image depending on the second image narrowed down from the second image satisfying the search condition.

13. The image processing system according to claim 10, wherein the first image is associated with identification information for identifying the first image,
the processor executes further instruction to determine the identification information for identifying the second image satisfying the search condition, based on the identification information associated with the first image which is a basis of the second image;
wherein the processor uses the identification information received from the user terminal to obtain the first image or the generated image depending on the second image narrowed down from the second image satisfying the search condition.

14. The image processing system according to claim 11, wherein the identification information is information including at least one of a capturing date and time of an image, a capturing location of the image, an imaging device capturing the image, or a feature of the image.

15. The image processing system according to claim 12, wherein the identification information is information including at least one of a capturing date and time of an image, a capturing location of the image, an imaging device capturing the image, or a feature of the image.

16. The image processing system according to claim 13, wherein the identification information is information including at least one of a capturing date and time of an image, a capturing location of the image, an imaging device capturing the image, or a feature of the image.

17. The image processing system according to claim 2, the processor executes further instruction to
receive information about a search item of the search condition designated from an outside,
wherein the processor detects the second image satisfying the search item of the search condition received.

18. The image processing system according to claim 3, the processor executes further instruction to
receive information about a search item of the search condition designated from an outside,
wherein the processor detects the second image satisfying the search item of the search condition received.

19. The image processing system according to claim 5, the processor executes further instruction to
receive information about a search item of the search condition designated from an outside,
wherein the processor detects the second image satisfying the search item of the search condition received.

20. The image processing system according to claim 6, the processor executes further instruction to
receive information about a search item of the search condition designated from an outside,
wherein the processor detects the second image satisfying the search item of the search condition received.
